(19) United States
(12) Patent Application Publication
(10) Pub. No.: US 2015/0286989 A1
(43) Pub. Date: Oct. 8, 2015

(54) SYSTEMS AND METHODS FOR SEARCHING RESIDENTIAL AND COMMERCIAL PROPERTY, MODIFYING PROPERTIES IN THE RESULT SET, AND INTEGRATING THOSE MODIFICATIONS WITH SERVICE PROVIDERS

(71) Applicant: Karla Alvarado, San Antonio, TX (US)

(72) Inventor: Karla Alvarado, San Antonio, TX (US)

(21) Appl. No.: 14/678,971

(22) Filed: Apr. 4, 2015

Related U.S. Application Data
(60) Provisional application No. 61/975,672, filed on Apr. 4, 2014.

(51) Int. Cl. G06Q 10/10; G06F 17/30; G06Q 50/16

(52) U.S. Cl. CPC G06Q 10/10; G06Q 50/16; G06F 17/30554; G06F 17/30312; G06F 17/30247; G06F 17/3028

(57) ABSTRACT

Disclosed herein is a system and method for searching real estate property through a web based, client server, or mobile architecture and performing modifications through the system such as structural floor plan changes and interior design changes to those properties in the result set to help facilitate the selection of a home or commercial space. In an embodiment, the system is comprised of a search component and a design component. The search component allows an individual to search for properties based on a number of criteria. The design component allows an individual to select a property in the result set and perform modifications to the property to assist the individual in visualizing their desired end results. In another embodiment, the system is also comprised of a goods and services component for estimating costs and receiving proposals for implementing those modifications from a vendor or through a personal project.

### CROSS-REFERENCE TO RELATED APPLICATIONS

This application claims the benefit under Title 35 United States Code §119(e) of U.S. Provisional Patent Application Ser. No.: 61/975,672; Filed: Apr. 4, 2014, the full disclosure of which is incorporated herein by reference.

### STATEMENT REGARDING FEDERALLY SPONSORED RESEARCH OR DEVELOPMENT

Not applicable

### THE NAMES OF THE PARTIES TO A JOINT RESEARCH AGREEMENT

Not applicable

### INCORPORATING-BY-REFERENCE OF MATERIAL SUBMITTED ON A COMPACT DISC

Not applicable

### SEQUENCE LISTING

Not applicable

### FIELD OF THE INVENTION

The present invention generally relates to systems and methods for searching real estate property. More specifically, the present invention generally relates to systems and methods for searching residential and commercial property through a web based, client server, or mobile architecture and making modifications such as structural floor plan changes and interior design changes to those properties in the result set to help facilitate the selection of a home or commercial space.

### BACKGROUND OF THE INVENTION

Without limiting the scope of the disclosed systems and methods, the background is described in connection with novel systems and methods for searching real estate property.

The search for residential or commercial property can be a time consuming and iterative process with several disparate sources of information being brought together to visualize an end product. In addition, the seller or leasor of residential or commercial property often negotiates changes to the property with a potential buyer or leasee. These negotiations often involve estimates and can also be an iterative process with several disparate sources of information being brought together to visualize an end product.

As an example, one of the most common processes utilized in searching for a home or for commercial space starts with searches through tools such as Zillow®, Trulia®, and the MLS®. An individual is able to retrieve a listing of properties based on their search. As the properties are reviewed, often is the case that properties are close to what the individual desires but there are often aspects of the property that would need to be changed. For example, there is an interior wall that needs to be removed, an interior wall that needs to be added, the ceiling fans need to be replaced, the roof type needs to be changed, the color of the walls changed, or a window needs to be added. Many times the individual is not able to visualize the change or may not even take the time to research the effort and cost to make the modification forcing the individual to move on to the next property in the result set. For those individuals that continue to investigate, they may call a vendor or contractor to research further the effort and cost for the modifications. Information for the modification such as colors, materials, styles, positioning, and measurements are usually estimated and the information is provided multiple times to each vendor or contractor. In further addition to this, the modifications may only be exploratory in nature. The individual may want to add a new window to a wall in the home, but they are not firm on the size, color, or type. Often the individual has a best guess as to how the modification will look but is left trying to best visualize the change. As can be seen, the process is very iterative in nature working with various sources such as the seller or leasor, the realtors, and the contractors or vendors.

As a second example, when the seller or leasor of the residential or commercial property is in negotiations with a potential buyer or leasee, the requested changes or fixes to the property often become a point of contention. As previously illustrated, the modifications can be a very iterative process with several disparate sources of information being brought together in an attempt to visualize an end product acceptable to the buyer or leasee.

The conventional approaches and processes described are very time consuming and costly and it is very difficult to visualize the end product.

What is desired, therefore, is a system that manages the search and modification process of residential and commercial property in an automated and systematic manner thereby reducing the efforts in terms of cost and time while accurately providing a visual representation of the end product prior to the modifications being started. By achieving these desires, residential and commercial property can be sold more efficiently and effectively.

### BRIEF SUMMARY OF THE INVENTION

Accordingly, it is an object of the present invention to provide a system that manages the search and modification process of residential and commercial property in an automated and systematic manner thereby reducing the efforts in terms of cost and time while accurately providing a visual representation of the end product prior to the modifications being actually started. It is a further object of the present invention to provide a system that manages the processes of searching residential and commercial properties, modification of those properties in the search result set, and integration with vendors and/or contractors to offer services and products to complete those modifications in an efficient and effective manner.

These and other objects of the present invention are achieved by a system for providing searches of residential and commercial properties and modifications to those properties in the result set which includes a computer having software executed thereon for transmitting queries and for receiving responses to the transmitted queries. The system also includes software for managing the result set or responses to the transmitted queries and making modifications to selected residential or commercial properties. These modifications may include but not be limited to adding and removing interior walls, changing room colors, changing floors, adding and removing windows, adding and removing furniture, and changing the roof type. In an embodiment the modifications are further integrated with vendors and contractors for estimating costs and receiving proposals for implementing those modifications from a vendor, contractor, or through a personal project.

In an another embodiment, the present invention, therefore, provides for a system and method for searching real estate property through a web based, client server, or mobile architecture and performing modifications through software such as structural floor plan changes and interior design changes to those properties in the result set to help facilitate the selection of a home or commercial space. In an embodiment, the system is comprised of a search component and a design component. The search component allows an individual to search for active properties based on a number of criteria such as but not limited to price, geographic location, number of bedrooms, number of baths, property type, number of square feet, lot size, and year built. The design component allows an individual to select a property in the result set and perform modifications to the property to assist the individual in visualizing their desired end results. In another embodiment, the system is also comprised of a goods and services component for estimating costs and receiving proposals for implementing those modifications from a vendor, contractor, or through a personal project.

In summary, the present invention discloses novel systems and methods for searching real estate property through a web based, client server, or mobile architecture and making modifications to those properties in the result set to help facilitate the selection of residential or commercial space.

### BRIEF DESCRIPTION OF THE SEVERAL VIEWS OF THE DRAWINGS

For a more complete understanding of the features and advantages of the present invention, reference is now made to the detailed description of the invention along with the accompanying figures in which:

FIG. 1 is a system architecture diagram of the system for searching and modifying residential and commercial property in accordance with embodiments of the disclosure;

FIG. 2 is a software block diagram of the system for searching and modifying residential and commercial property in accordance with embodiments of the disclosure;

FIG. 3 is a work flow diagram of the search component of the system for searching and modifying residential and commercial property in accordance with embodiments of the disclosure;

FIG. 4 is a work flow diagram of the design component of the system for searching and modifying residential and commercial property in accordance with embodiments of the disclosure;

FIG. 5 is a work flow diagram of the goods and services component of the system for searching and modifying residential and commercial property in accordance with embodiments of the disclosure;

### DETAILED DESCRIPTION OF THE INVENTION

Disclosed herein is an improved device and method of use directed to searching real estate property. The numerous innovative teachings of the present invention will be described with particular reference to several embodiments (by way of example, and not of limitation).

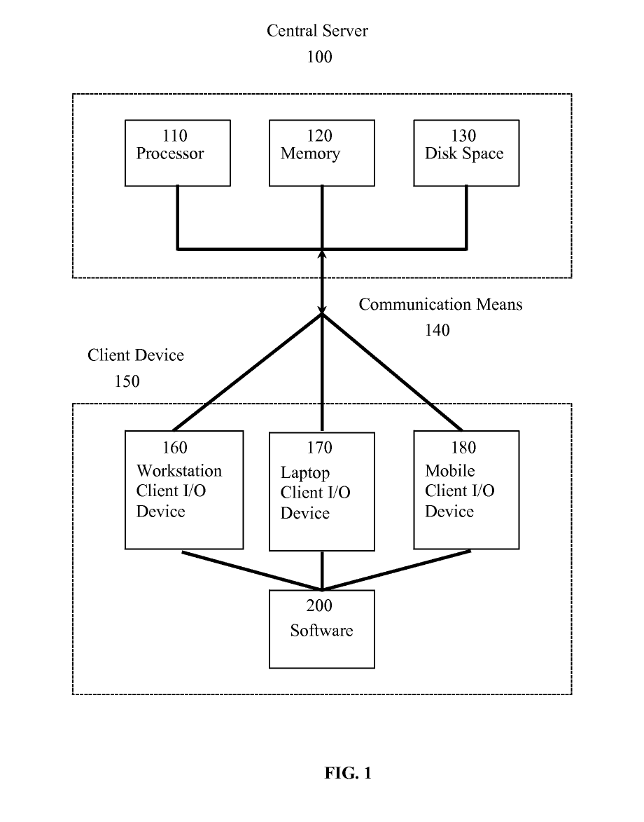

Reference is first made to FIG. 1, a system architecture diagram of the system for searching and modifying residential and commercial property in accordance with embodiments of the disclosure. In one embodiment, the system is comprised of a central server 100 and a client input and output device or also referred to as a client display 150. The central server 100 having at least a processor 110 for processing instructions, memory 120 to support processing operations, and disk space 130 for the storage of data. The central server 100 is configured for storing the residential and commercial property data for executing queries against. The client input and output device 150 having at least the means for receiving information from the central server 100, the means to present that information to the user, and the ability to send information back to the central server 100 for processing and/or storage. In another embodiment, the client input and output device may be a workstation 160, a laptop 170, or a mobile device 180. Whereas, the central server 100 is configured to store and manage the data elements or information for the system and whereas the central server 100 is communicatively coupled 140 to the client input and output device 150. Communicatively coupling may be achieved by wired or wireless connection. In another embodiment, the client input and output device 150 is configured to store and run software 200 for transmitting queries to the central server 100 and for receiving responses from the central server 100 to the transmitted queries. The client input and output device 150 is also configured to store and run software for managing the result set or responses to the transmitted queries, making modifications to selected residential or commercial properties, and storing those results. In another embodiment the central server 100 and client input and output device 150 is one device or computer. In yet another embodiment, the client input and output device 150 is configured to connect to a third party or database repository that houses the residential and commercial property data to query against.

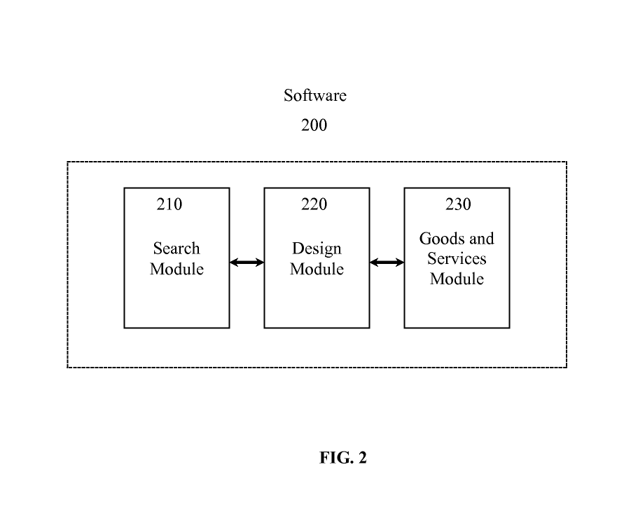

Reference is next made to FIG. 2, a software block diagram of the system for searching and modifying residential and commercial property in accordance with embodiments of the disclosure. Illustrated are the three main modules or components of the software 200 for the system for searching and modifying residential and commercial properties. The first one is the search module or component 210, the second is the design module or component 220, and the third is the goods and services module or component 230. In an embodiment, all three of these modules are integrated with each other in the processing and sharing of data elements so as to help facilitate to efficiency and effectiveness of the system.

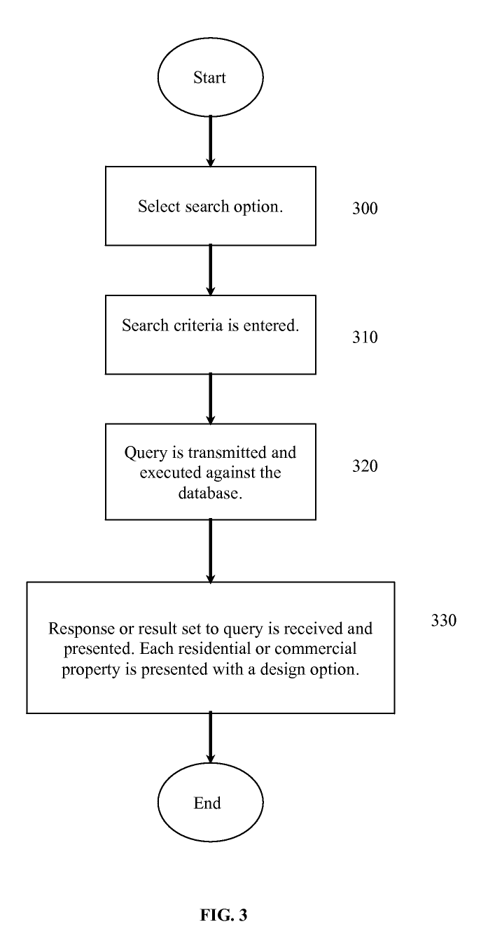

Reference is now made to FIG. 3, a work flow diagram of the search component of the system for searching and modifying residential and commercial property in accordance with embodiments of the disclosure. Initially provided by the system is a search option 300. Once the search option 300 is selected the system provides for the creation of queries 310. The queries may be constructed to include a number of criteria such as but not limited to price, price range, price limits, geographic location, geographic areas, number of bedrooms, number of baths, property type, number of square feet, lot size, status, and year built. Once the queries are constructed, the system allows for the query to be submitted 320 against a residential and commercial property database that stores the residential and commercial property data. These queries may be submitted 320 to a residential and commercial property listing database residing on the central server 100, the client input and output device 150, or through a connection to a third party or service provider such as the MLS®. The results are returned and presented to the user of the system for review 330. As a user of the system steps through the results which may be presented in summary form, the system provides the functionality to select a property and drill down into further details of the property such as but not limited to seeing photos, the listing agent, room dimensions, and floor plans. Often times when searching through properties, a home may be close to what is desired but may need some upgrades or modifications. The system, therefore, provides for the selection of properties in the result set 330 and the option to select the design option for the property.

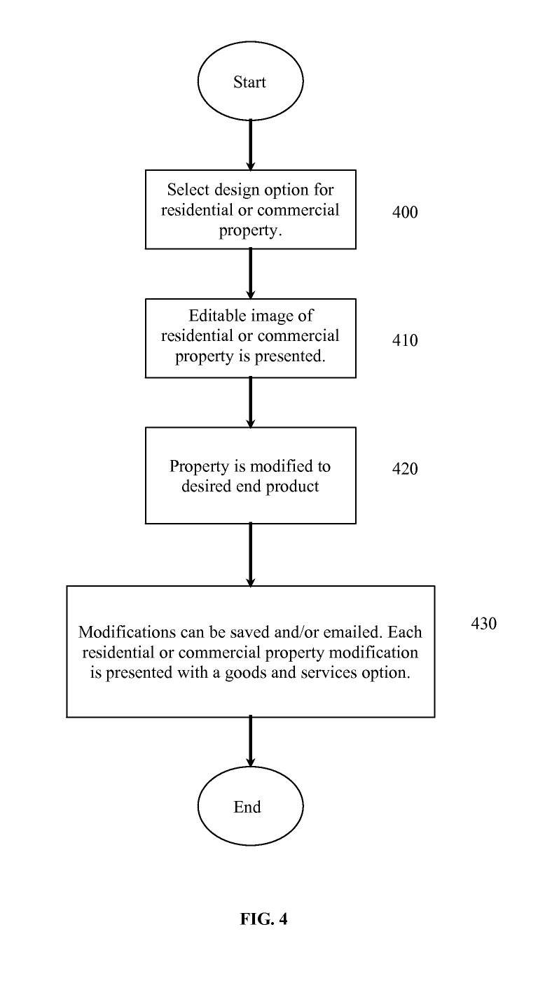

Reference is next made to FIG. 4, a work flow diagram of the design component of the system for searching and modifying residential and commercial property in accordance with embodiments of the disclosure. Once a residential or commercial property is identified to design with, the design option is selected 400. This option may be presented to the user by but not limited to a tab, a selection button, or a pop up window. Once the design option is selected 400 an editable image of the residential or commercial property is presented 410 by the system. In an embodiment, the editable image may be presented in a 2D or a 3D image format. These editable images are stored in the database and can be uploaded through various means such as but not limited to an existing editable plan stored on the central server 100, client input and output device 150, or the third party or database repository. The editable plan may also be created, for example, by the listing realtor with the software residing on the central server 100, client input and output device 150, or the third party or database repository. As another option, the editable plan may also be created by tracing over a non-editable floor plan uploaded by the user of the system. In yet another embodiment, the editable plan is created on the fly from the residential or commercial photos by the software residing on the central server 100, client input and output device 150, or the third party or database repository and received/stored by the system with the associated property. The system provides for the modification of the editable images to the desired end product 420. These modifications may include but not be limited to adding and removing interior walls, changing room colors, changing floors, adding and removing windows, adding and removing furniture, adding or changing window treatments, adding a bathroom, changing cabinets, change or add lighting, and changing the roof type. At any point in the modification or design process, the changes can be saved to a file, emailed, or stored on the system 430. The system provides for the data element tracking of the modifications. That is, the information is tracked and stored for each modification. For example, if a wall is changed to another color, the color chosen and walls dimensions are tracked and stored. As another example, if a floor type is changed, the new type (such as wood), style, size, and floor square footage is tracked and stored. This information can all be saved to a file, emailed, or printed allowing the user of the system to take this information with him. Based on the modifications, a user may desire to move forward with the selection of the home and/or want more information regarding the modifications made in the design portion of the system. The system, therefore, provides for the selection of modifications made to the editable floor plan images 420 and the option to select the goods and services option for the modification. In another embodiment, the system allows the selection first of the goods and services option before selecting any modifications if needed.

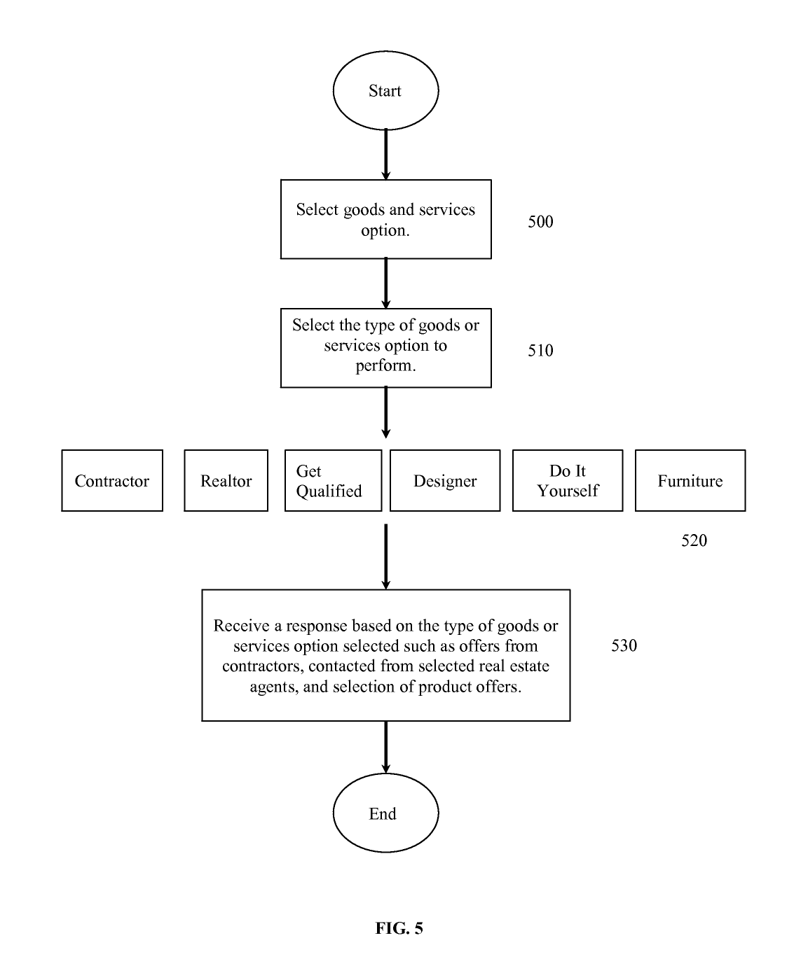

Reference is now made to FIG. 5, a work flow diagram of the goods and services component of the system for searching and modifying residential and commercial property in accordance with embodiments of the disclosure. Once the goods and services option is selected 500, several options of goods and services are presented 510, such as but not limited to contractor, realtor, get qualified, designer, do it yourself, and furniture 520. The system provides several integrations based on the option selected 530.

If the realtor option 520 is selected, realtors are listed to assist the user in visiting and purchasing/selling the home. In an embodiment, the realtor is a user of the system and receives notifications of requests in conjunction with the property and user information associated with the request 530. In an embodiment, notifications and requests may be through internal system messaging or through external email. The realtor is able to respond to the requests through the system. In an embodiment, the user may select to see the most used realtor and/or feedback provided for each realtor. A user of the system in an embodiment is an individual that has been provided access to the system such as through logon credentials (user name and password) for an account. Once in the system, the user may setup their account with additional information such as but not limited to name, address information, type of account (individual, company, vendor, service provider, email).

If the contractor option 520 is selected, contractors are listed to assist the user with receiving estimates on the modifications and completing the modifications. In an embodiment, modifications along with modification details can be selected by the user for individual processing with selected contractors. In an embodiment, the contractor is a user of the system and receives notifications of requests in conjunction with the property, selected modification details, and user information associated with the request 530. The contractor is able to respond to the requests through the system. In an embodiment, the user may select to see the most used contractor and/or feedback provided for each contractor.

If the get qualified option 520 is selected, loan officers are listed to assist the user in receiving funding for the property. In an embodiment, the loan officer is a user of the system and receives notifications of requests in conjunction with the property and user information associated with the request 530. The loan officer is able to respond to the requests through the system. In an embodiment, the user may select to see the most used loan officer and/or feedback provided for each loan officer.

If the designer option 520 is selected, interior designers are listed to assist the user in their design needs. In an embodiment, the designer is a user of the system and receives notifications of requests in conjunction with the property and user information associated with the request 530. The designer is able to respond to the requests through the system. In an embodiment, the user may select to see the most used designers and/or feedback provided for each designer.

If the do it yourself option 520 is selected, suppliers of goods are listed to assist the user with estimating the cost of supplies for completing the modifications. Suppliers of goods may be vendors such as Lowest and Home Depot®. In an embodiment, modifications along with modification details can be selected by the user for individual processing with selected suppliers of goods. In an embodiment, the supplier of goods is a user of the system and receives notifications of requests in conjunction with the property, selected modification details, and user information associated with the request 530. The supplier of goods is able to respond to the requests through the system. In an embodiment, the user may select to see the most used supplier of goods and/or feedback provided for each supplier of goods.

If the furniture option 520 is selected, furniture vendors are listed to assist the user with estimating the cost of selected items and purchasing those items. In an embodiment, modifications along with modification details can be selected by the user for individual processing with selected furniture vendors. In an embodiment, the furniture vendor is a user of the system and receives notifications of requests in conjunction with the property, selected modification details, and user information associated with the request 530. The furniture vendor is able to respond to the requests through the system. In an embodiment, the user may select to see the most used furniture vendors and/or feedback provided for each furniture vendor.

In brief, the invention is directed to a system and method for searching real estate property. More specifically, the present invention generally relates to systems and methods for searching real estate property through a web based, client server, or mobile architecture and making modifications such as structural floor plan changes and interior design changes to those properties in the result set to help facilitate the selection of a home or commercial space.

The disclosed system and method is generally described, with examples incorporated as particular embodiments of the invention and to demonstrate the practice and advantages thereof. It is understood that the examples are given by way of illustration and are not intended to limit the specification or the claims in any manner.

To facilitate the understanding of this invention, a number of terms may be defined below. Terms defined herein have meanings as commonly understood by a person of ordinary skill in the areas relevant to the present invention. Terms such as “a”, “an”, and “the” are not intended to refer to only a singular entity, but include the general class of which a specific example may be used for illustration. The terminology herein is used to describe specific embodiments of the invention, but their usage does not delimit the disclosed system or method of use, except as may be outlined in the claims.

Alternative applications for this invention include using the system or method in any application where searches are performed for a product, modifications are needed for at least one product in the result set, and those modifications are integrated with vendors to offer their services or products to achieve those modifications. Consequently, any embodiments comprising a one piece or multi piece system having the components or structures as herein disclosed with similar function shall fall into the coverage of claims of the present invention and shall lack the novelty and inventive step criteria.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific systems and methods described herein. Such equivalents are considered to be within the scope of this invention and are covered by the claims.

All publications and patent applications mentioned in the specification are indicative of the level of those skilled in the art to which this invention pertains. All publications, patents, and patent application are herein incorporated by reference to the same extent as if each individual publication, patent, or patent application was specifically and individually indicated to be incorporated by reference.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

The systems and/or methods of use disclosed and claimed herein can be made and executed without undue experimentation in light of the present disclosure. While the systems and methods of this invention have been described in terms of preferred embodiments, it will be apparent to those skilled in the art that variations may be applied to the systems and/or methods in the steps or in the sequence of steps of the method described herein without departing from the concept, spirit, and scope of the invention.

More specifically, it will be apparent that certain components, which are both shape and material related, may be substituted for the components described herein while the same or similar results would be achieved. All such similar substitutes and modifications apparent to those skilled in the art are deemed to be within the spirit, scope, and concept of the invention as defined by the appended claims.

What is claimed is:

1. A real estate property search system comprising:
a central server configured for storing and processing residential and commercial property data, receiving and processing queries against said residential and commercial property data, and returning a result set;
a client input/output device communicatively coupled to said central server and said client input/output device configured for sending residential and commercial property queries to said central server and receiving from said central server a result set to said query;
said central server configured to receive, store, and process editable images of a residential or commercial property selected by a user of the system from the result set.

2. The system of claim 1, wherein said client I/O device is a workstation.

3. The system of claim 1, wherein said client I/O device is a laptop.

4. The system of claim 1, wherein said client I/O device is a mobile device.

5. The system of claim 1, further configured with a search component.

6. The system of claim 1, further configured with a design component.

7. The system of claim 5, further configured with a design component.

8. The system of claim 1, further configured with a goods and services component.

9. The system of claim 7, further configured with a goods and services component.

10. A real estate property search system comprising:
a device configured for storing and processing residential and commercial property data, processing queries against said residential and commercial property data, and returning a result set;
said device configured to store and process editable image of residential and commercial property selected by a user of the system from the result set.

11. The system of claim 10, further configured with a search component.

12. The system of claim 10, further configured with a design component.

13. The system of claim 11, further configured with a design component.

14. The system of claim 10, further configured with a goods and services component.

15. The system of claim 13, further configured with a goods and services component.

16. A method of searching real estate property and modifying selected real estate properties in the result set comprising the steps of:
selecting the search option;
entering search criteria;
executing the query against a residential and/or commercial property database;
presenting the result set with a design option.

17. The method of claim 16, further comprising the steps of:
selecting the design option for a residential or commercial property in the result set;
present an editable image of the residential or commercial property selected;
modifying the image and store modifications.

18. The method of claim 17, further comprising the step of:
presenting a goods and services option.

19. The method of claim 18, further comprising the steps of:
selecting the goods and services option for a modification made to the residential or commercial property image;
selecting the type of goods or services option to perform for the modification or residential or commercial property selected;
receiving a response back from the type of goods or services option selected.

20. The method of claim 19, wherein the residential or commercial property image is 3D and the goods and services option is selected from the group consisting of service providers and provider of goods.
